(19) United States
(12) Patent Application Publication
(10) Pub. No.: US 2007/0231651 A1
(43) Pub. Date: Oct. 4, 2007

(54) Fuel cell with insulating element

(75) Inventors: Stefan Haufe, Gottingen (DE); Annette Reiche, Gottingen (DE); Dieter Melzner, Gottingen (DE); Fabian Walter, Gottingen (DE)

Correspondence Address: CASELLA & HESPOS, 274 MADISON AVENUE, NEW YORK, NY, 10016, US

(73) Assignee: Sartorius AG, Gottingen (DE)

(21) Appl. No.: 11/716,506

(22) Filed: Mar. 9, 2007

(30) Foreign Application Priority Data
Apr. 1, 2006 (DE) 10 2006 015 247.6

(51) Int. Cl. H01M 8/10; H01M 2/08

(52) U.S. Cl. 429/32; 429/35

(57) ABSTRACT

The invention relates to an insulating element for a fuel cell stack, which is composed of a thermally insulating plastic or plastic composite material. The insulating element is connected to the end plate and the bipolar end plate of the stack and achieves virtually uniform distribution of temperature and flow density along the fuel cell stack in the cell operating mode. As a result, the condensation of product water is prevented. The efficiency of the fuel cell stack is increased since it is possible to dispense with external heating of the stack by a cell current and costly measuring and control technology,

### BACKGROUND OF THE INVENTION

1. Field of the Invention

The invention relates to a fuel cell having at least one insulating element for thermally and electrically insulating a fuel cell stack.

2. Description of the Related Art

Planar fuel cell stacks which are connected in a bipolar fashion are composed of a plurality of diaphragm electrode units (MEA) which are connected in a series, the electronic contacts being formed and the reaction media and heat exchanging media being fed in by means of what are referred to as bipolar plates (BPP). Contact is made with the respectively last BPP of a stack, also referred to as a bipolar end plate (BPEP), by a collector plate (KP) via which the current is fed.

One or more units composed of a diaphragm electrode unit and a bipolar plate are clamped in between two end plates (EP), for example with tie rods, in order to minimize electronic contact resistances and at the same time apply the contact pressure for the seals which are arranged between the MEA and the BPP or, if appropriate, also between the two duct plates of a BPP, between the BPEP and KP and/or between the KP and EP, in order to ensure the media in the stack are sealed from the inside and from the outside.

During operation, homogeneous distribution of temperature over the fuel cell stack is a precondition for a homogenous current/voltage characteristic of all the individual cells. In particular, heat which is generated during the fuel cell reaction and cannot be used is irradiated into the surroundings via the end plates, which leads to a nonuniform distribution of temperature along the stack. For example, the temperature of the end cells may be colder than that of the remaining cells of the stack. This temperature difference can lead, for example, to the condensation of water in the inlet region or outlet region of the stack and to a nonhomogeneous current/voltage characteristic curve along the stack.

US 20010036568 A1 discloses heating the end plate of a fuel cell stack using a temperature sensor with an electric heating element in order to ensure homogeneous distribution of temperature. In a similar way, WO 2004064182 A2 discloses heating the cells of a stack which are adjacent to the BPEP or those which are adjacent to the end plates EP, by means of a resistance heating element which is connected in parallel. These arrangements have the disadvantage that current is drawn to heat the fuel cell stack, thus reducing the efficiency of the fuel cell system. Furthermore, additional costly components are required and the expenditure on control is increased.

In WO 2004006370 A2, the cells of a fuel cell stack have a modified distributor structure for the operating media. The inflow via the distributor structure varies as a function of the position of the individual cell in the fuel cell stack, and permits a volume flow for the outer end cells to be set which differs by at least 30% from that of the central cell in the interior of the stack. This modification of the end cells compared to the internal cells allows virtually uniform distribution of temperature along the stack to be achieved. It is disadvantageous in terms of structural engineering and control technology that the first and last fuel cell of the stack require a different design from the intermediate fuel cells owing to the modified distributor structure.

JP 9007628 discloses a fuel cell having a thermal insulating block composed of carbon, which is arranged between end plates and a carbon plate. The carbon plate bounds the last and first electric cells in a fuel cell stack. The insulating block is intended to bring about uniform distribution of temperature in the fuel cell. Disadvantages are the large amount of space required by the insulating block, its mechanical sensitivity owing to the material used and its complicated duct structure through which media, electric cables and measuring devices are guided.

### SUMMARY OF THE INVENTION

The object of the present invention is to propose a fuel cell which has a simple design and a high degree of efficiency and whose waste reaction heat which is dissipated into the surroundings is minimized and whose temperature is very largely constant along the stack.

This object is achieved by the fuel cell according to the subject invention which has an insulating element which contains at least one plastic and, owing to its thermally insulating properties, it minimizes the temperature gradient prevailing in the fuel cell stack. Temperature gradient is to be understood as being the temperature difference prevailing between the cells adjacent to the end plates and the cells in the interior of the stack. The insulating element according to the subject invention minimizes the cooling of the end plates in the outer region of the fuel cell stack compared to the cells in the inner region of the stack and prevents the condensation of product water. This brings about a very largely homogeneous current/voltage characteristic curve for all the individual cells along the stack.

The insulating element can be cost-effectively manufactured from plastic and quickly integrated into the manufacturing process for fuel cell stacks without the individual cells of the stack having to be modified in terms of control technology.

### BRIEF DESCRIPTION OF THE DRAWINGS

FIG. 1 shows the design of a fuel cell stack according to the invention, with at least one insulating element 1;

FIG. 2 shows an insulating plate 1 in a plan view; and

FIG. 3 shows an insulating plate 1 in section.

### DETAILED DESCRIPTION OF THE PREFERRED EMBODIMENT

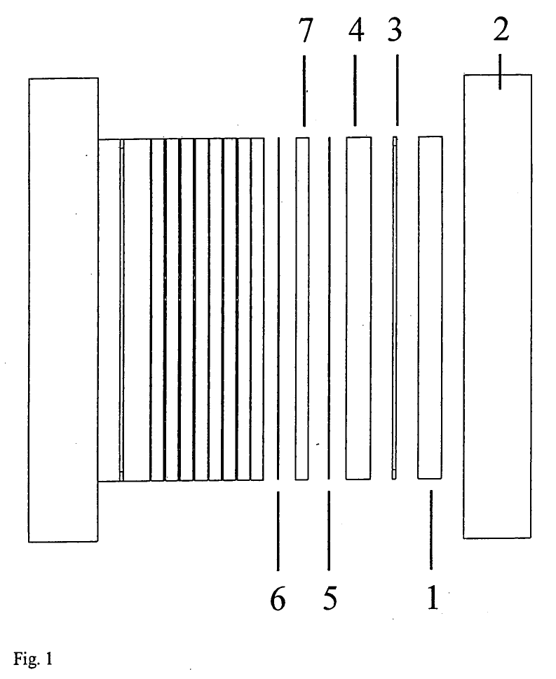

According to FIG. 1, an insulating element 1, preferably in the form of an insulating plate, is arranged in each case between an end plate 2 and collector plate 3. The collector plate is adjoined, toward the inside of the stack, by a BPEP 4, an MEA 5 adjoining the BPEP and x repeating units of MEA 6 and bipolar plate 7, x being a positive integer including 0.

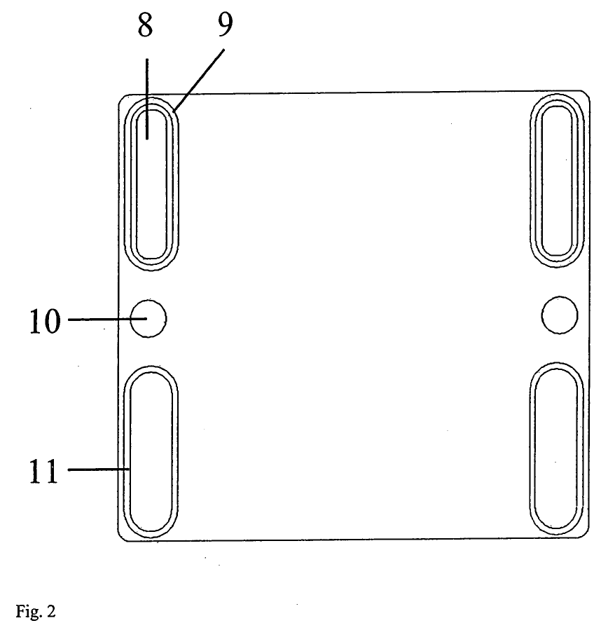

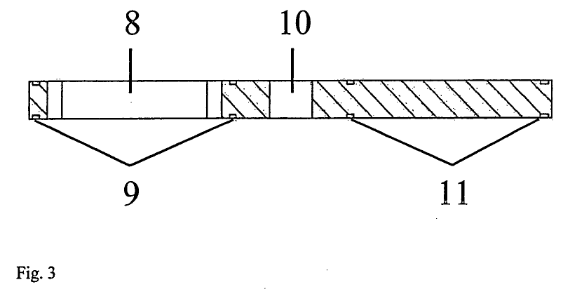

The insulating plate 1 has, according to FIGS. 2 and 3, breakthroughs 8, preferably with a rectangular shape with rounded corners, for feeding in fuel and oxidation media as well as for a heat exchanger. The breakthroughs can be sealed by means of seals, if appropriate between EP 2 and insulating element 1 and/or insulating element 1 and KP 3. The seals have the same shape as the breakthroughs 8, preferably rectangular with rounded corners, a groove 9 being provided as a depression for receiving a seal-forming O-ring (not shown) with the same shape as the groove.

The seal is formed by the two grooves 9 of the adjacent plates to be respectively sealed and the O-ring which is to be inserted. In one particularly preferred embodiment, the insulating element 1 also contains breakthroughs 10 for securing components during stacking, preferably circular in shape, and a further groove 11 of the same design as 9, in order to be able to use a further O-ring to connect the insulating element to the groove in its adjacent plate, preferably an EP 2 or KP 3, in a seal-forming fashion.

In an alternative embodiment (not shown), the arrangement is configured in such a way that the end plate is enclosed, on its side facing toward the outside of the stack by the insulating element, and on its side facing toward the interior of the stack, by one of the collector plates, the collector plate toward the inside of the stack adjoining one of the bipolar end plates.

In a further embodiment (not shown), the first insulating element is located between the collector plate and the first end plate as an outer stack boundary, as in FIG. 1, while the second end plate is located between the second insulating plate as an outer stack boundary and the collector plate. Both insulating plates are fabricated from the same material or from different materials.

In a further alternative embodiment, the insulating element and end plate are combined to form a single element which can be plate-shaped and whose side facing toward the inside of the stack adjoins a collector plate, the collector plate toward the inside of the stack adjoining a bipolar end plate.

The thermal conductivity of the insulating plate is preferably less than 1.0 W/(Km), preferably less than 0.9 W(Km), and particularly preferably less than 0.8 W/(Km). The thickness of the plate is preferably 0.05 to 5.00 cm, preferably 0.1 to 3.0 cm, and particularly preferably 0.4 to 2.0 cm, and permits assembly in a way which does not take up much installation space.

The insulating plate 1 is preferably composed of plastic such as polyimide, polyamidide, polyetheretherketone, polyetherimide, polyethersulfone, polytetrafluoroethylene or polyphenylenesulfide or plastic composite materials which contain these plastics with glass fiber or carbon fiber reinforcement. In a further preferred embodiment of the invention, foamed polymers or a composite material whose core is composed of polymers which are foamed in a microporous fashion can also be used.

Plastics are distinguished both by low thermal conductivity and also by the fact that they are for the most part electrically insulating. A short circuit via the end plates 2, which are composed for example of steel, titanium or aluminum, is thus ruled out.

The material of the insulating plate 1 is matched to the operating temperature range of the fuel cell. The preferred embodiments of the insulating element 1 according to the invention can be used in the operating temperature range up to 250° C. The material which is used for the insulating plate 1 is characterized by the continuous use temperature which is expediently above the operating temperature of the fuel cell stack. At the continuous use temperature, the insulating element 1 must be capable of being used virtually without limitation, without chemical, thermal or mechanical decomposition while maintaining the insulating properties according to the invention. An overview of the materials used for the insulating element 1, and their properties, is given in table 1.

### EXAMPLE

The insulating plate 1 is composed of 40% by weight glass-fiber-reinforced polyphenylenesulfide (tecatron GF 40, Ensinger). The material has a continuous temperature of 230° C. and has a coefficient of thermal conductivity of 0.25 W/(Km) as well as a volume resistivity of 10¹³ Ωcm (cf. Table 1). The insulating plate 1 is 5.0 mm thick and has, as illustrated in FIG. 2 and FIG. 3, in each case a breakthrough 8 for air and one for combustion gas. The seal of the media breakthroughs in the insulating plate 1 with respect to the collector plate 3 and the end plate 2 is provided by means of an O-ring which is located in a groove 9. The O-ring (38.0×1.5 mm) is composed of Viton (FPM 80) and lies 1.0 mm into the groove 9.

TABLE 1

| | | | | Volume |
|---|---|---|---|---|
| | | Continuous use | Coefficient of thermal | resistivity/ |
| Material | Abbreviation | temperature/° C. | conductivity/W/(Km) | Ωcm |
| Polyimide | PI | 300 | 0.35 | 10¹⁵ |
| Polyamidimide | PAI | 260 | 0.26 | 10¹⁵ |
| Polyetheretherketone | PEEK | 260 | 0.25 | 10¹⁶ |
| Polyphenylenesulfide | PPS | 230 | 0.25 | 10¹³ |
| Polyetherimide | PEI | 170 | 0.22 | 10¹⁵ |
| Polysulphone | PSU | 160 | 0.25 | 10¹⁶ |

What is claimed is:

1. Fuel cell having two end plates (2) which hold at least one fuel cell stack in the manner of a sandwich, which fuel cell stack is composed of a sequence of a first collector plate (3), a first bipolar end plate (4), a diaphragm electrode unit (5), a number x of repeating units comprising a bipolar plate (7) and diaphragm electrode unit (6), a second bipolar end plate (4) and a second collector plate (3), x being a positive integer including 0, characterized in that the fuel cell has insulating elements (1) which are adjacent to the end plates and contain plastic.

2. Fuel cell according to claim 1, characterized in that the insulating elements (1) are at least thermal insulating elements.

3. Fuel cell according to claim 1, characterized in that the insulating elements (1) are thermal and electrical insulating elements.

4. Fuel cell according to claim 1, characterized in that the insulating elements (1) are arranged on the side of the end plates (2) facing the fuel cell stack.

5. Fuel cell according to claim 1, characterized in that the insulating elements (1) are integrated into the end plate (2).

6. Fuel cell according to claim 1, characterized in that the insulating elements (1) have a thermal conductivity of less than 1.0 W/(Km).

7. Fuel cell according to claim 1, characterized in that the insulating elements (1) constitute plates.

8. Fuel cell according to claim 7, characterized in that the thickness of the plates of the insulating elements (1) is at least 0.05 cm.

9. Fuel cell according to claim 7, characterized in that the plates have breakthroughs (8) for feeding in at least one medium.

10. Fuel cell according to claim 9, characterized in that the breakthroughs (8) have seals.

11. Fuel cell according to claim 10, characterized in that the breakthroughs (8) between the end plate (2) and insulating element (1) and/or between the insulating element (1) and the collector plate (3) can be sealed by means of the seals.

12. Fuel cell according to claim 7, characterized in that the at least one medium is a fuel and/or oxidation medium and/or a heat exchanging medium.

13. Fuel cell according to claim 12, characterized in that the plates of the insulating elements (1) are composed of at least one plastic composite material.

14. Fuel cell according to claim 13, characterized in that the at least one plastic is polytetrafluoroethylene, polyphenylene sulfide, polyimide, polyamidide, polyetheretherketone, polyetherimide, polysulfone and/or a foamed polymer.

15. Fuel cell according to claim 13, characterized in that the at least one plastic composite material is glass-fiber-reinforced or carbon-fiber reinforced polytetrafluoroethylene, glass-fiber-reinforced or carbon-fiber-reinforced polyphenylenesulfide, glass-fiber-reinforced or carbon-fiber-reinforced polyimide, glass-fiber-reinforced or carbon-fiber-reinforced polyamidimide, glass-fiber-reinforced or carbon-fiber-reinforced polyetheretherketone, glass-fiber-reinforced or carbon-fiber-reinforced polyetherimide and/or glass-fiber-reinforced and/or carbon-fiber-reinforced polysulfone.

16. Fuel cell according to claim 15, characterized in that at least the core of the at least one plastic composite material is composed of a microporous, foamed polymer.

17. Fuel cell according to claim 16, which can be used in the operating temperature range of the fuel cell stack up to 250° C.
